(19) United States
(12) Patent Application Publication
(10) Pub. No.: US 2020/0278023 A1
(43) Pub. Date: Sep. 3, 2020

(54) SHIFT DEVICE

(71) Applicant: KABUSHIKI KAISHA TOKAI-RIKA-DENKI-SEISAKUSHO, Aichi (JP)

(72) Inventors: Makoto YAMAMOTO, Aichi (JP); Yoshinobu YOKOYAMA, Aichi (JP); Toshiharu KATAGIRI, Aichi (JP); Mizuho MARUYAMA, Aichi (JP); Munetoshi MAKIMURA, Aichi (JP)

(21) Appl. No.: 16/646,181

(22) PCT Filed: Aug. 23, 2018
(86) PCT No.: PCT/JP2018/031198

§ 371 Date: Mar. 11, 2020

(30) Foreign Application Priority Data
Sep. 13, 2017 (JP) 2017-175412

(51) Int. Cl. F16H 59/08; F16H 61/24; F16H 61/22

(52) U.S. Cl. CPC F16H 59/08; F16H 61/24; F16H 2061/243; F16H 2059/081; F16H 61/22

(57) ABSTRACT

In a shift device, operating projections of a rotor cam restrict movement of restricting plates of a click body toward a lower side. Due to movement of the click body toward the lower side being restricted, separating of click pins from concave portions is restricted, and rotation of a knob from a shift position is restricted. Therefore, by using the click body (the click pins) and a click surface (the concave portions), rotation of the knob from a shift position can be restricted, and rotation of the knob can be restricted by a simple structure.

### TECHNICAL FIELD

The present invention relates to a shift device at which a shift body is moved, and a shift position is changed.

### BACKGROUND ART

In the shift device disclosed in Japanese Patent Application National Publication (JP-A) No. 2016-539836, a locking element engages with the locking contour of an operating element, and rotation of the operating element is locked. Further, an anchor pin is engaged with an anchoring contour of the operating element by spring force.

Here, in such a shift device, it is desirable to be able to lock rotation of the operating element by a simple structure.

### SUMMARY OF INVENTION

### Technical Problem

In view of the above-described circumstances, an object of the present invention is to provide a shift device that can restrict movement of a shift body by a simple structure.

### Solution to Problem

A shift device of a first aspect of the present invention comprises: a shift body that is supported at a vehicle body side, and that is moved to change a shift position thereof; an urged portion that is provided at one of the vehicle body side or the shift body, and that is urged; an engaging portion that is provided at another of the vehicle body side or the shift body, that engaged with the urged portion by urging force such that the shift body is urged toward a shift position side, and that disengages with the urged portion against the urging force such that the shift body is moved from a shift position; and a restricting portion that restricts disengagement of the urged portion with the engaging portion, such that movement of the shift body from a shift position is restricted.

A shift device of a second aspect of the present invention comprises, in the shift device of the first aspect of the present invention, a limiting portion that limits engagement of the urged portion with the engaging portion by the urging force.

### Advantageous Effects of Invention

In the shift device of the first aspect of the present invention, the shift body is supported at the vehicle body side. The shift body is moved, and the shift position thereof is changed. The urged portion is provided at one of the vehicle body side or the shift body, and the engaging portion is provided at the another of the vehicle body side or the shift body. The urged portion is engaged with the engaging portion by urging force, and the shift body is urged toward a shift position side. The engagement of the urged portion with the engaging portion is cancelled against the urging force, and the shift body is moved from a shift position.

Here, the restricting portion restricts the canceling of the engagement of the urged portion with the engaging portion, and movement of the shift body from a shift position is restricted. Therefore, by using the urged portion and the engaging portion, movement of the shift body from a shift position can be restricted, and movement of the shift body can be restricted by a simple structure.

In the shift device of the second aspect of the present invention, the limiting portion limits the engaging of the urged portion with the engaging portion that is due to urging force. Therefore, the shift body can be moved from a shift position in a state in which urging force is not applied thereto.

### BRIEF DESCRIPTION OF DRAWINGS

FIG. 1 is an exploded perspective view showing main portions of a shift device relating to a first embodiment of the present invention.

FIG. 2A is a perspective view showing main portions of the shift device relating to the first embodiment of the present invention, and is a drawing showing a time when a rotor cam is disposed at a reference position.

FIG. 2B is a perspective view showing main portions of the shift device relating to the first embodiment of the present invention, and is a drawing showing a time when the rotor cam is rotated in one direction from the reference position.

FIG. 3 is a cross-sectional view showing main portions of a shift device relating to a second embodiment of the present invention.

### DESCRIPTION OF EMBODIMENTS

### First Embodiment

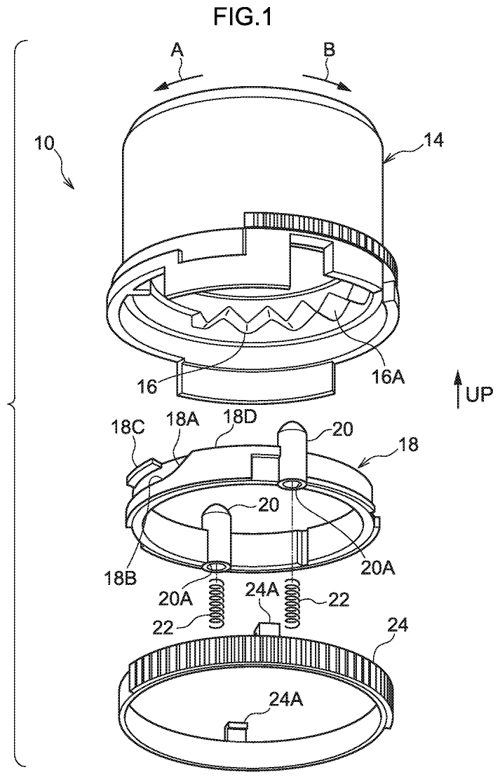

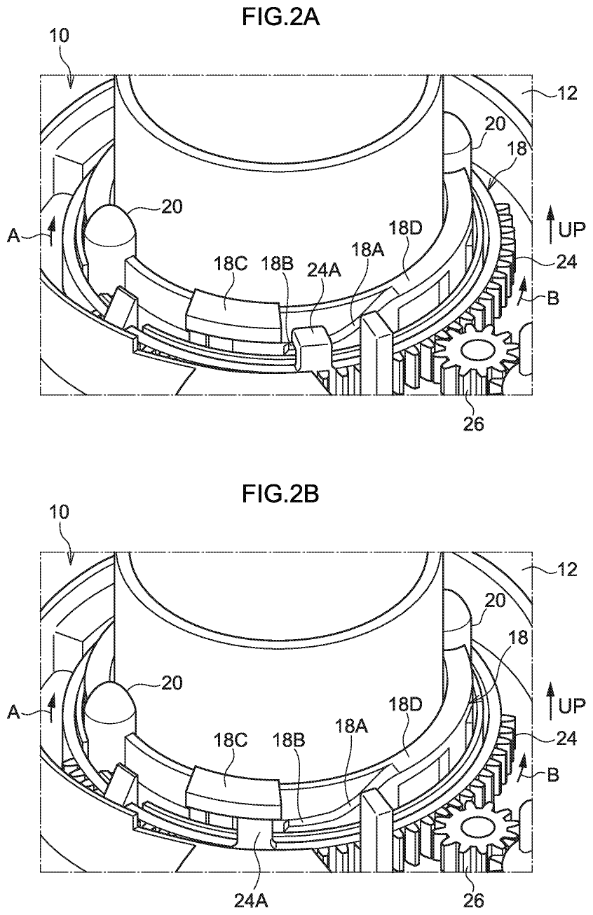

Main portions of a shift device 10 relating to a first embodiment of the present invention are shown in FIG. 1 in an exploded perspective view. Main portions of the shift device 10 are shown in FIG. 2A in a perspective view. Note that, in the drawings, the upward direction of the shift device 10 is indicated by arrow UP.

The shift device 10 relating to the present embodiment is set at a console (not illustrated) of a vehicle (an automobile), and is disposed at the vehicle front side and the vehicle transverse direction inner side of the driver's seat (not illustrated) of the vehicle. The upper side of the shift device 10 coincides with the upper side of the vehicle.

As shown in FIG. 1 and FIG. 2A, a plate 12 that serves as a vehicle body side is provided at the shift device 10. The plate 12 is fixed to the interior of the console.

A knob 14, which is substantially shaped as a cylindrical tube having a bottom and serves as a shift body (an operating body), is supported at the upper side of the plate 12. The interior of the knob 14 opens toward the lower side, and the knob 14 can rotate (move) around the vertical direction. The knob 14 can rotate a predetermined range in one direction (the direction of arrow A in FIG. 1 and the like) and in another direction (the direction of arrow B in FIG. 1 and the like). The knob 14 can be disposed at, for example, a “P” position (parking position), an “R” position (reverse position), an “N” position (neutral position) and a “D” position (drive position) that serve as shift positions, in that order from the another direction side toward the one direction side.

The knob 14 is passed-through the console so as to be able to rotate, and projects-out into the vehicle cabin, and the knob 14 is rotatingly operated by a vehicle occupant. A rotating mechanism (not illustrated) serving as a moving mechanism is mechanically connected to the knob 14. Due to the rotating mechanism being driven, the knob 14 can rotate in at least one of the one direction and the another direction.

A click surface 16 that structures a click mechanism is formed at the inner peripheral side of the lower end portion of the knob 14. The click surface 16 faces toward the lower side, and extends in the peripheral direction (the rotation peripheral direction) of the knob 14. Plural concave portions 16A serving as an engaging portion are provided at the click surface 16. The plural concave portions 16A are disposed continuously in the peripheral direction of the knob 14, and the portions between the concave portions 16A are curved in the peripheral direction of the knob 14.

A click body 18, which is substantially annular and serves as an urged body and structures the click mechanism, is provided at the lower side of the knob 14. The click body 18 is disposed coaxially at the interior of the knob 14, and is supported at the upper side of the plate 12 so as to be movable in the vertical direction and so as to be unable to rotate. A pair of click pins 20, which are substantially shaped as solid cylinders and serve as an urged portion, are provided integrally with the click body 18. The pair of click pins 20 face one another across the central axis of the click body 18. The click pins 20 project-out toward the upper side, and the upper surfaces of the click pins 20 are curved in shapes that are convex toward the upper side. Supporting holes 20A that are solid cylindrical are formed coaxially within the click pins 20, and the supporting holes 20A open toward the lower side.

Springs 22 (compression coil springs), which serve as an urging portion and structure the click mechanism, are provided at the lower sides of the respective click pins 20 of the click body 18. The springs 22 are fit-together with the interiors of the supporting holes 20A of the click pins 20. The springs 22 span between the plate 12 and the bottom surfaces (the upper surfaces) of the supporting holes 20A of the click pins 20, and the springs 22 urge the click body 18 toward the upper side. At times when the knob 14 is disposed at the respective shift positions, due to the urging forces of the springs 22, the click pins 20 are inserted in (engaged with) the concave portions 16A of the click surface 16 of the knob 14, and the knob 14 is held at the respective shift positions. At times when the knob 14 is rotatingly operated between the shift positions, the click pins 20 separate from the concave portions 16A (the engagement with the concave portions 16A is cancelled) while the click body 18 is moved toward the lower side against the urging forces of the springs 22. Thereafter, while the click body 18 is moved toward the upper side by the urging forces of the springs 22, the click pins 20 are inserted in the concave portions 16A, and a clicking sensation is imparted to the rotational operation of the knob 14.

Inclined surfaces 18A serving as a moving portion are formed at radial direction outer side portions of the click body 18, at the respective peripheral direction positions between the click pins 20. The inclined surfaces 18A are inclined in directions of heading toward the lower side while heading toward the one direction side. Permitting surfaces 18B serving as a permitting portion are formed at radial direction outer side portions of the click body 18, at further toward the one direction sides than the respective inclined surfaces 18A. The permitting surfaces 18B extend from the lower ends of the inclined surfaces 18A toward the one direction sides, at the lower ends of the inclined surfaces 18A or at vertical direction positions that are further toward the lower side than the inclined surfaces 18A. Restricting plates 18C, which are substantially rectangular plate shaped and serve as a restricting portion, are formed integrally with the click body 18 at positions that are apart from the respective inclined surfaces 18A toward the one direction sides. The restricting plates 18C extend in the peripheral direction of the click body 18 at vertical direction positions of the upper end portions of the inclined surfaces 18A, and face the permitting surfaces 18B in the vertical direction. Limiting surfaces 18D serving as a limiting portion are formed at the click body 18 at the another direction sides of the respective inclined surfaces 18A. The limiting surfaces 18D extend from the upper ends of the inclined surfaces 18A toward the another direction sides, at the vertical direction positions of the upper ends of the inclined surfaces 18A.

A rotor cam 24, which is substantially annular and serves as an operating member (rotating member) and structures the restricting portion and the limiting portion, is provided at the lower side of the knob 14. The rotor cam 24 is rotatably supported at the upper side of the plate 12, and is disposed coaxially with the knob 14 at the radial direction outer side of the click body 18. A pair of operating projections 24A, which are shaped as L-shaped plates in cross-section and serve as an operating portion, are provided integrally with the rotor cam 24. The pair of operating projections 24A face one another across the central axis of the rotor cam 24. The proximal end side portions of the operating projections 24A project-out toward the upper side. The distal end side portions of the operating projections 24A project-out toward the radial direction inner side of the rotor cam 24. The rotated position of the rotor cam 24 is located at the reference position (start position), and the distal end side portions of the operating projections 24A are disposed at the upper sides of the another direction side (the inclined surface 18A side) end portions of the permitting surfaces 18B of the click body 18 (see FIG. 2A).

A driving mechanism 26, which structures the restricting portion and the limiting portion, is mechanically connected to the rotor cam 24. The driving mechanism 26 is driven, and the rotor cam 24 can rotate in the one direction and the another direction.

Operation of the present embodiment is described next.

In the shift device 10 of the above-described structure, at times when the knob 14 is disposed at the respective shift positions, due to the urging forces of the springs 22, the click pins 20 of the click body 18 are inserted in the concave portions 16A of the click surface 16 of the knob 14, and the knob 14 is held at the respective shift positions. At times when the knob 14 is rotated between the shift positions, the click pins 20 separate from the concave portions 16A while the click body 18 is moved toward the lower side against the urging forces of the springs 22. Thereafter, while the click body 18 is moved toward the upper side by the urging forces of the springs 22, the click pins 20 are inserted into the concave portions 16A, and a clicking sensation is imparted to the rotational operation of the knob 14.

On a first occasion that is at a time when the knob 14 is disposed at a predetermined shift positions (e.g., the “P” position) (e.g., in a case in which the brake of the vehicle is not operated by the vehicle occupant), due to the driving mechanism 26 being driven and the rotor cam 24 being rotated in the one direction from the reference position, the distal end side portions of the operating projections 24A of the rotor cam 24 are moved to the lower sides of the restricting plates 18C of the click body 18, and the distal end side portions of the operating projections 24A restrict movement of the restricting plates 18C toward the lower side (see FIG. 2B). Therefore, due to movement of the click body 18 toward the lower side being restricted and separation of the click pins 20 from the concave portions 16A being restricted, the click pins 20 restrict rotation of the concave portions 16A, and rotation of the knob 14 from the predetermined shift position is restricted (locked).

On the other hand, in a case in which the state of the first occasion, which is at a time when the knob 14 is disposed at a predetermined shift position (e.g., the “P” position) is cancelled (e.g., in a case in which the brake of the vehicle is operated by the vehicle occupant), due to the driving mechanism 26 being driven and the rotor cam 24 being rotated in the another direction, the rotor cam 24 is disposed at (returned to) the reference position, and the distal end side portions of the operating projections 24A permit movement of the restricting plates 18C toward the lower side (see FIG. 2A). Therefore, movement of the click body 18 toward the lower side is permitted, and separation of the click pins 20 from the concave portions 16A is permitted. Due thereto, the click pins 20 permit rotation of the concave portions 16A, and restricting of rotation of the knob 14 from the predetermined shift position is canceled (unlocked).

On a second occasion (e.g., a case in which the engine of the vehicle is turned OFF in a state in which the knob 14 is disposed at other than a specific shift position (e.g., the “P” position)), before the rotating mechanism is driven and the knob 14 is rotated toward the specific shift position, the driving mechanism 26 is driven, and the rotor cam 24 is rotated in the another direction from the reference position. Due thereto, the distal end side portions of the operating projections 24A of the rotor cam 24 are moved to the upper sides of the limiting surfaces 18D via the inclined surfaces 18A of the click body 18, and the distal end side portions of the operating projections 24A move the click body 18 toward the lower side against the urging forces of the springs 22. Therefore, insertion of the click pins 20 into the concave portions 16A is limited, and application of the urging forces of the springs 22 to the knob 14 is limited. Due thereto, at the time when the rotating mechanism is driven, and the knob 14 is rotated toward the specific shift position, the knob 14 is rotated in a state in which the urging forces of the springs 22 are not applied to the knob 14.

On the other hand, at the time when the rotating mechanism is driven, and the knob 14 is rotated to the specific shift position, due to the driving mechanism 26 being driven and the rotor cam 24 being rotated in the one direction, the rotor cam 24 is disposed at (returned to) the reference position, and the click body 18 is moved toward the upper side by the urging forces of the springs 22. Therefore, the click pins 20 are inserted into the concave portions 16A by the urging forces of the springs 22, and the knob 14 is held at the specific shift position.

Here, as described above, the rotor cam 24 (the operating projections 24A) restrict the separating of the click pins 20 from the concave portions 16A, and rotation of the knob 14 from the predetermined shift position is restricted. Therefore, by using the click body 18 (the click pins 20) and the click surface 16 (the concave portions 16A), rotation of the knob 14 from the predetermined position can be restricted, and rotation of the knob 14 can be restricted by a simple structure, and the number of parts can be reduced.

Further, as described above, at the time when the rotating mechanism is driven, and the knob 14 is rotated toward the specific shift position, the rotor cam 24 (the operating projections 24A) limit insertion of the click pins 20 into the concave portions 16A by the urging forces of the springs 22. Therefore, the rotating mechanism can rotate the knob 14 in a state in which the urging forces of the springs 22 are not applied to the knob 14, and the rotating mechanism can easily rotate the knob 14.

Moreover, as described above, due to the rotor cam 24 being rotated in the peripheral direction of the knob 14, rotation of the knob 14 is restricted, and application of the urging forces of the springs 22 to the knob 14 is limited. Therefore, differently than in a case in which the rotor cam 24 is moved in the radial direction of the knob 14, the need to provide moving space for the rotor cam 24 at the radial direction outer side or radial direction inner side of the knob 14 can be eliminated.

### Second Embodiment

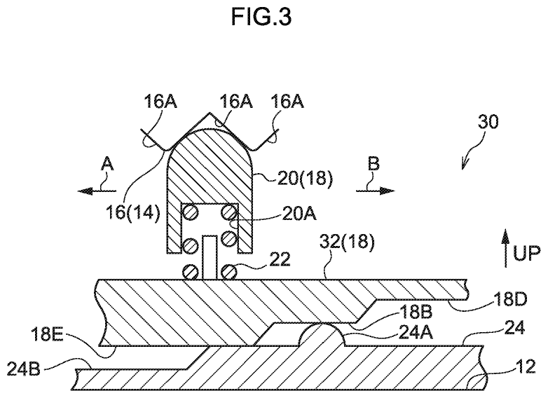

Main portions of a shift device 30 relating to a second embodiment of the present invention are shown in FIG. 3 in a cross-sectional view.

The shift device 30 relating to the present embodiment has a structure that is substantially similar to that of the above-described first embodiment, but differs with respect to the following points.

As shown in FIG. 3, in the shift device 30 relating to the present embodiment, a spring base 32, which is substantially annular and serves as a base portion, is provided coaxially at the click body 18. The spring base 32 is supported at the upper side of the plate 12 so as to be able to move in the vertical direction and so as to be unable to rotate.

The pair of click pins 20 are supported at the upper side of the spring base 32 so as to be able to move in the vertical direction. The springs 22 are fit-together with the interiors of the supporting holes 20A of the click pins 20. The springs 22 span between the upper surface of the spring base 32 and the bottom surfaces (the upper surfaces) of the supporting holes 20A of the click pins 20, and the springs 22 urge the click pins 20 toward the upper side. At times when the knob 14 is rotatingly operated between shift positions, while the click pins 20 are moved toward the lower side against the urging forces of the springs 22, the click pins 20 separate from the concave portions 16A of the click surface 16 of the knob 14 (the engagement with the concave portions 16A is cancelled). Thereafter, while the click pins 20 are moved toward the upper side by the urging forces of the springs 22, the click pins 20 are inserted into the concave portions 16A, and a clicking sensation is imparted to the rotational operation of the knob 14.

The pair of permitting surfaces 18B are formed at the lower surface of the spring base 32. The pair of permitting surfaces 18B face one another across the central axis of the spring base 32, and respectively extend in the peripheral direction of the spring base 32. Restricting surfaces 18E serving as a restricting portion are formed at the lower surface of the spring base 32, at the one direction sides of the respective permitting surfaces 18B. The restricting surfaces 18E extend in the peripheral direction of the spring base 32. The border portions between the permitting surfaces 18B and the restricting surfaces 18E are inclined in directions of heading toward the lower side while heading toward the one direction side, and the restricting surfaces 18E are disposed further toward the lower side than the permitting surfaces 18B. The limiting surfaces 18D are formed at the lower surface of the spring base 32, at the another direction sides of the respective permitting surfaces 18B. The limiting surfaces 18D extend in the peripheral direction of the spring base 32. The border portions between the permitting surfaces 18B and the limiting surfaces 18D are inclined in directions of heading toward the upper side while heading toward the another direction side, and the limiting surfaces 18D are disposed further toward the upper side than the permitting surfaces 18B.

The rotor cam 24 is disposed at the lower side of the spring base 32. The pair of operating projections 24A, which are substantially shaped as semicircular pillars, are provided integrally with the upper surface of the rotor cam 24. The operating projections 24A project-out toward the upper side. The upper surfaces of the operating projections 24A are curved in convex shapes in the peripheral direction (the rotation peripheral direction) of the rotor cam 24. The rotated position of the rotor cam 24 is disposed at the reference position (the start position), and the operating projections 24A are disposed at the lower sides of the permitting surfaces 18B of the spring base 32 and support the spring base 32 from the lower side at the permitting surfaces 18B.

Insertion holes 24B are formed in the rotor cam 24 at positions that are apart, toward the one directions sides, from the respective operating projections 24A. The insertion holes 24B open toward the upper side. The insertion holes 24B extend in the peripheral direction of the rotor cam 24. The end surfaces at the another direction sides (the operating projection 24A sides) of the insertion holes 24B are inclined in directions heading toward the lower side while heading toward the one direction side.

By the way, on a first occasion that is at a time when the knob 14 is disposed at a predetermined shift position (e.g., the “P” position) (e.g., in a case in which the brake of the vehicle is not operated by the vehicle occupant), due to the driving mechanism 26 being driven and the rotor cam 24 being rotated in the one direction from the reference position, the operating projections 24A of the rotor cam 24 are moved from the lower sides of the permitting surfaces 18B of the spring base 32 to the lower sides of the restricting surfaces 18E, and move the spring base 32 toward the upper side. Therefore, movement of the click pins 20 toward the lower side is restricted by the spring base 32, and separating of the click pins 20 from the concave portions 16A is restricted. Due thereto, the click pins 20 restrict rotation of the concave portions 16A, and rotation of the knob 14 from the predetermined shift position is restricted (locked).

On the other hand, in a case in which the state of the first occasion, which is at the time when the knob 14 is disposed at a predetermined shift position (e.g., the “P” position) is cancelled (e.g., in a case in which the brake of the vehicle is operated by the vehicle occupant), due to the driving mechanism 26 being driven and the rotor cam 24 being rotated in the another direction, the rotor cam 24 is disposed at (returned to) the reference position, and the spring base 32 is moved toward the lower side. Therefore, movement of the click pins 20 toward the lower side is permitted, and separation of the click pins 20 from the concave portions 16A is permitted. Due thereto, the click pins 20 permit rotation of the concave portions 16A, and restricting of rotation of the knob 14 from the predetermined shift position is canceled (unlocked).

Further, on a second occasion (e.g., a case in which the engine of the vehicle is turned OFF in a state in which the knob 14 is disposed at other than a specific shift position (e.g., the “P” position)), before the rotating mechanism is driven and the knob 14 is rotated toward the specific shift position, the driving mechanism 26 is driven, and the rotor cam 24 is rotated in the another direction from the reference position. Due thereto, the operating projections 24A of the rotor cam 24 are moved from the lower sides of the permitting surfaces 18B of the spring base 32 to the lower sides of the limiting surfaces 18D, and the spring base 32 is moved toward the lower side while the restricting surface 18E portions of the spring base 32 are inserted into the insertion holes 24B of the rotor cam 24. Therefore, due to the click pins 20 and the springs 22 being moved toward the lower side together with the spring base 32, insertion of the click pins 20 into the concave portions 16A is limited, and application of the urging forces of the springs 22 to the knob 14 is limited. Due thereto, at the time when the rotating mechanism is driven, and the knob 14 is rotated toward the specific shift position, the knob 14 is rotated in a state in which the urging forces of the springs 22 are not applied to the knob 14.

On the other hand, at the time when the rotating mechanism is driven, and the knob 14 is rotated to the specific shift position, due to the driving mechanism 26 being driven and the rotor cam 24 being rotated in the one direction, the rotor cam 24 is disposed at (returned to) the reference position, and the spring base 32 is moved toward the upper side while the restricting surface 18E portions of the spring base 32 separate from the insertion holes 24B of the rotor cam 24. Therefore, due to the click pins 20 and the springs 22 being moved toward the upper side together with the spring base 32, the click pins 20 are inserted into the concave portions 16A by the urging forces of the springs 22, and the knob 14 is held at the specific shift position.

Here, in the present embodiment as well, operation and effects that are similar to the above-described first embodiment can be obtained.

Note that, in the above-described first embodiment and second embodiment, the click pins 20 are inserted into the concave portions 16A in the axial direction (the rotation axial direction) of the knob 14. However, for example, the click pins 20 may be inserted into the concave portions 16A in the radial direction (the rotation radial direction) of the knob 14.

Moreover, in the above-described first embodiment and second embodiment, the click surface 16 (the concave portions 16A) is provided at the knob 14, and the click body 18 (the click pins 20) is provided at the plate 12 (the vehicle body side). However, the click body 18 (the click pins 20) may be provided at the knob 14, and the click surface 16 (the concave portions 16A) may be provided at the plate 12 (the vehicle body side).

Further, in the above-described first embodiment and second embodiment, the rotor cam 24 (the operating member) is rotated in the peripheral direction of the knob 14. However, for example, the operating member may be moved in the radial direction (the rotation radial direction) or the axial direction (the rotation axial direction) of the knob 14.

Moreover, in the above-described first embodiment and second embodiment, the knob 14 (the shift body) is rotatingly operated. However, the shift body may be pivotally operated or slidingly operated. In this case, for example, by extending the knob 14 out in the radial direction and providing the operating portion so as to be able to rotate integrally therewith, the operating portion may be pivotally operated and the knob 14 rotated.

Further, in the above-described first embodiment and second embodiment, the shift devices 10, 30 are set at the console. However, the shift devices 10, 30 may be set at the instrument panel or the column cover.

The disclosure of Japanese Patent Application No. 2017-175412 is, in its entirety, incorporated by reference into the present specification.

1. A shift device comprising:
a shift body that is supported at a vehicle body side, and that is moved to change a shift position thereof;
an urged portion that is provided at one of the vehicle body side or the shift body, and that is urged;
an engaging portion that is provided at another of the vehicle body side or the shift body, that engaged with the urged portion by urging force such that the shift body is urged toward a shift position side, and that disengages with the urged portion against the urging force such that the shift body is moved from a shift position; and
a restricting portion that restricts disengagement of the urged portion with the engaging portion, such that movement of the shift body from a shift position is restricted.

2. The shift device of claim 1, further comprising a limiting portion that limits engagement of the urged portion with the engaging portion by the urging force.

3. The shift device of claim 1, wherein the engaging portion is a concave portion.

4. The shift device of claim 1, wherein the restricting portion includes a rotor cam that is substantially annular, and a driving mechanism.
